(19) United States
(12) Patent Application Publication
(10) Pub. No.: US 2010/0162714 A1
(43) Pub. Date: Jul. 1, 2010

(54) FUEL NOZZLE WITH SWIRLER VANES

(76) Inventors: Edward Claude Rice, Indianapolis, IN (US); Timothy Carl Roesler, Plainfield, IN (US); Mindi Danette Wigal, Columbus, IN (US); Bruce Varney, Greenwood, IN (US)

Correspondence Address: KRIEG DEVAULT LLP, ONE INDIANA SQUARE, SUITE 2800, INDIANAPOLIS, IN, 46204-2079, US

(21) Appl. No.: 12/636,487

(22) Filed: Dec. 11, 2009

Related U.S. Application Data
(60) Provisional application No. 61/203,961, filed on Dec. 31, 2008.

(51) Int. Cl. F02C 7/22

(52) U.S. Cl. 60/748

(57) ABSTRACT

A fuel nozzle for a gas turbine engine is provided having swirlers and a mounting device configured to mount the fuel nozzle to the inside of a combustor. In one embodiment the combustor has an interior surface formed to receive the mounting device of the fuel nozzle from within the combustor. The swirlers can be integrally formed in the fuel nozzle or can be separately attached, thus allowing the fuel nozzle to be mounted within the combustor having the relative placement of the swirlers already determined prior to installation. The fuel nozzle tip can be positioned a predetermined distance from the outlet of a swirler to reduce NOx emissions.

### CROSS REFERENCE TO RELATED APPLICATIONS

The present application claims the benefit of U.S. Provisional Patent Application 61/203,961, filed Dec. 31, 2008, and is incorporated herein by reference.

### FIELD OF INVENTION

The present invention generally relates to gas turbine engine combustors, and more particularly, but not exclusively, to fuel nozzles used within gas turbine engine combustors.

### BACKGROUND

Configuring fuel nozzles and swirler arrangements within gas turbine engine combustors remains an area of interest for improving combustor performance and reducing NOx emissions. Unfortunately, some existing systems have various shortcomings relative to certain applications. Accordingly, there remains a need for further contributions in this area of technology.

### SUMMARY

One embodiment of the present invention is a unique fuel nozzle. Other embodiments include apparatuses, systems, devices, hardware, methods, and combinations for fuel nozzles having integrated swirlers. Further embodiments, forms, features, aspects, benefits, and advantages of the present application shall become apparent from the description and figures provided herewith.

### BRIEF DESCRIPTION OF THE FIGURES

FIG. 1 is a schematic representation of a gas turbine engine having one embodiment of the application.

FIG. 2 is a partial cross-sectional drawing of an embodiment of the application.

### DETAILED DESCRIPTION OF REPRESENTATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

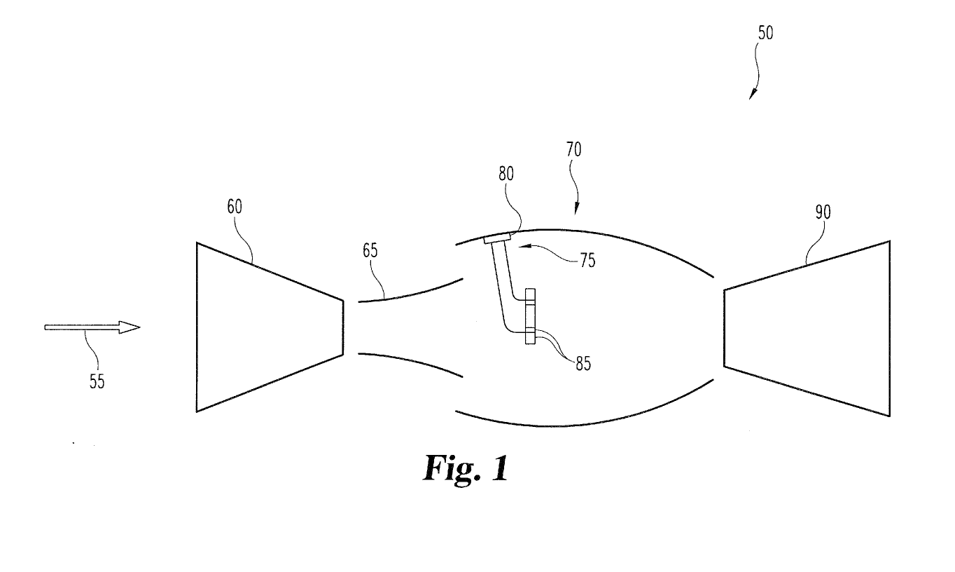

With reference to FIG. 1, there is illustrated a schematic representation of a gas turbine engine 50 that can be used as an aircraft powerplant. The term aircraft includes, but is not limited to, airplanes, fixed wing vehicles, variable wing vehicles, unmanned space vehicles, unmanned combat aerial vehicles, and others. Further, the present inventions are contemplated for utilization in other applications that may not be coupled with an aircraft such as, for example, industrial applications, power generation, pumping sets, naval propulsion and other applications known to one of ordinary skill in the art.

Airflow 55 enters compressor 60 of gas turbine engine 50 and is compressed prior to entering the diffuser 65 having a cross sectional area that expands in a downstream direction to diffuse the airflow 55 prior to entering a combustor 70. In the illustrative embodiment the fuel nozzle 75 is attached to an interior surface of combustor 70 by a mounting device 80. The fuel nozzle includes swirlers 85 that are structured to swirl the flow traversing the combustor 70. The swirlers 85 include a first and second swirler. Turbine 90 is located downstream of combustor 70 and is used to extract mechanical energy from the flow. It is important to note that the schematic representation illustrated in FIG. 1 is not limited to any particular type of gas turbine engine. Rather, gas turbine engine 50 may take the form of a turbojet, turbofan, and others, to list just a few nonlimiting examples.

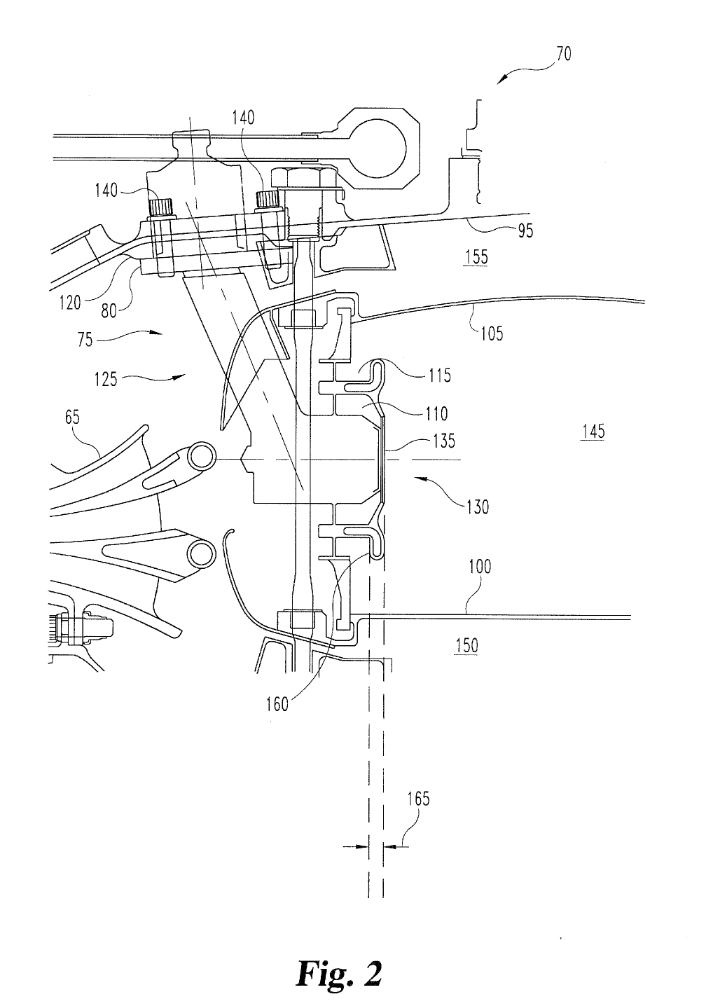

FIG. 2 depicts a partial cross-sectional drawing of another embodiment of the application. Diffuser 65 provides airflow to the interior of combustor casing 95. Fuel nozzle 75 in the illustrative embodiment is mounted internal to the combustor casing 95 between an inner liner 100 and outer liner 105. The fuel nozzle 75 includes a first swirler 110 and second swirler 115.

Diffuser 65 is configured as a tri-pass diffuser in the illustrated embodiment and is mounted upstream from the first swirler 110 and second swirler 115. In some embodiments the diffuser 65 can be configured as a single pass diffuser, or may have any number of separate passages that split and diffuse the compressor discharge flow. Some applications may not require use of a diffuser. Though only two swirlers 110 and 115 are depicted, other embodiments can include additional or fewer swirlers.

Combustor casing 95 provides a housing for the combustor 70 and is located between the diffuser 65 and the turbine 90 (shown in FIG. 1). In some embodiments, however, the combustor casing 95 may extend over a greater or lesser distance. The combustor casing 95 includes a mounting surface 120 configured to receive the mounting device 80 of the fuel nozzle 75. In some embodiments the mounting surface 120 can be a unitary portion of the combustor casing 95, and in other embodiments the mounting surface 120 can be separately made and attached to the combustor casing 95.

Mounting surface 120 is configured as a mount pad in the illustrated embodiment and can have a generally planar surface geometry. The mount pad can be capable of withstanding thermal, mechanical, and pressure loads experienced throughout an engine operation and contains an aperture through which passes part of the fuel nozzle 75 or other mechanisms that support the transfer of fuel from a location exterior to combustor casing 95. In some embodiments the generally planar surface geometry of the mounting surface 120 can be replaced by other configurations, such as, for example, a curvilinear shape or a discontinuous sawtooth shape, to set forth just two nonlimiting examples. The mounting surface 120 is configured to cooperatively receive the mounting device 80 of the fuel nozzle 75. In some embodiments the mounting surface 120 may not be present at all such that the mounting device 80 of the fuel nozzle 75 attaches directly to the interior of the combustor casing 95.

In one form the fuel nozzle 75 includes an elongate fuel nozzle body 125 and a fuel nozzle head 130. A fuel nozzle tip 135 is disposed at the end of the fuel nozzle head 130 and defines the area in which fuel is injected into the combustor 70. The fuel nozzle body can reside entirely within combustor casing 95, but in other embodiments the fuel nozzle body can extend to the exterior of combustor casing 95. In some embodiments the fuel nozzle 75 can be configured having solely a fuel nozzle body 125 and can take on any variety of shapes. In one form the fuel nozzle 75 and mounting device 80 are configured to be pressure loaded within the combustor casing 95.

Mounting device 80 is coupled to the fuel nozzle 75 and is structured to be cooperatively received by the mounting surface 120 of the combustor casing 95. In some applications additional structure may be interposed between the mounting device 80 and the mounting surface 120. Mounting device 80 can be integrally formed with fuel nozzle 75 in some embodiments. Mounting device 80 is disposed between the fuel nozzle head 130 and an end of the fuel nozzle 75, but in some embodiments can be disposed at the end of the fuel nozzle 75. The mounting device 80 can be configured to have a complementary shape to the mounting surface 120. In some embodiments, however, the geometry of the mounting surface 120 need not be complementary of the mounting device 80. The mounting device 80 includes a portion that is capable of engaging the mounting surface 120 or other structure such that the mounting device 80 prevents the fuel nozzle 75 from being moved further than the interaction between the mounting surface 120, or other structure, and mounting device 80 permit. When the fuel nozzle 75 is coupled to the combustor 70 and the gas turbine engine 50 is in operation, the mounting device 80 is loaded via a pressure distribution acting upon it in a direction toward the mounting surface 120. In one form the mounting device 80 includes an outer portion that extends beyond the aperture in the mounting surface 120 such that the fuel nozzle 75 is prevented from moving further past the aperture in the mounting surface 120. In other forms the outer portion of the mounting device 80 can include a variety of shapes, the outer periphery of which can include at least some portions larger than the aperture in the mounting surface 120. In the illustrative form bolts 140 are used to attach the mounting device 80 to the mounting surface 120. In other forms, the mounting device 80 can be coupled to the mounting surface 120 by welding and magnetic coupling, among potential other techniques.

In the illustrative embodiment the fuel nozzle 75 is shown as being pressure mounted within the combustor 70. The mounting device 80 forms an area which receives a pressure force which can be the result of operating the combustor 70. As fuel is mixed and burned with air the pressure within the combustor 70 is generally higher than ambient. The mounting device 80 receives this pressure force and conveys it to the mounting surface 120 which provides a force that further secures the fuel nozzle 75 within the combustor 70. Other configurations of the fuel nozzle 75 and other structure can be used to provide different configurations of a pressure mount. In some embodiments the fuel nozzle 75 need not be pressure mounted at all.

Inner liner 100 and outer liner 105 define a combustion zone 145 internal to the combustor 70. Passageways 150 and 155 are defined between the inner and outer liners 100 and 105 and the combustor casing 95, and are configured to allow some portion of airflow to bypass the combustion zone 145, and in some instances, cool the products of combustion from the combustion zone 145 prior to entering the turbine 90. In some forms some portion of the airflow can enter the combustion zone 145 through either or both the inner and outer liners 100 and 105.

First swirler 110 is disposed adjacent to and radially offset from the fuel nozzle head 130 and is configured to impart a swirling motion to a portion of the air flowing through combustor 70. First swirler 110 is integrally formed in fuel nozzle 75, but in some embodiments it can be a separate assembly that is attached to the fuel nozzle 75. First swirler 110 can be displaced axially in some embodiments. First swirler 110 is configured as a series of circumferentially arranged aerodynamic vanes in the illustrated embodiment, but can take the form of a simple symmetric vane or tangentially drilled holes or passageways, to set forth just two nonlimiting examples. Additionally, first swirler 110 can be an assembly of vanes made up of any number of separate parts.

Second swirler 115 is located adjacent to and radially offset from the first swirler 110 and is integrated with the fuel nozzle 75. In one form the second swirler 115 is integrally formed with the first swirler 110 and/or the fuel nozzle 75. In other forms the second swirler 115 can be a separate assembly that is attached to the fuel nozzle 75 or other structure associated with the fuel nozzle 75. Additional swirlers can be integrally formed or integrated with the fuel nozzle 75 depending upon the needs of any given application. The second swirler 115 may not be needed in some embodiments that use only a single swirler.

Like first swirler 110, second swirler 115 can be configured as a series of circumferentially arranged aerodynamic vanes in the illustrated embodiment, but can take the form of simple symmetric vanes or tangentially drilled holes or passageways, to set forth just two alternative non-limiting examples. Additionally, second swirler 115 can be an assembly of vanes made up of any number of separate parts.

Second swirler has exit 160 that is positioned a distance 165 away from the tip 135 of the fuel nozzle 75 to improve one or more aspects of combustor performance and/or reduce NOx emissions. It will be understood, however, that the relative distance between the exit of any swirler, and the exit of another swirler and/or the tip of the nozzle can all affect combustion performance. This application is not limited to improving combustion performance through relative placement only of the second swirler exit and the nozzle.

In some applications the first swirler 110 and second swirler 115 are included with the fuel nozzle 75 prior to the fuel nozzle 75 being installed within the combustor 70. In this way the first swirler 110 and second swirler 115 can be positioned relative to the fuel nozzle 75 prior to being installed within the combustor 70.

A fuel nozzle having an integrated, or integral, swirler or swirlers as disclosed herein can be installed in a combustor without concern or much concern for affecting the intended, relative placement of the exits of any of the swirler or swirlers and the tip of a nozzle. This capability can be unlike the situation where a combustor first includes a preinstalled internal swirler (e.g. preinstalled in a combustor dome panel) and then a fuel nozzle is later inserted to a position adjacent to the swirler such that the swirler position relative to the fuel nozzle may vary according to manufacturing tolerances and/or thermal, mechanical, and/or pressure variations.

A fuel nozzle or fuel nozzle assembly as disclosed herein can include the mounting device and/or one or both of the swirlers. It will be understood that any combination of features is possible in the fuel nozzle or fuel nozzle assembly described herein. Some features can be releasably attached to each other in some embodiments, and in other embodiments the features can be integrally formed together to form one unit.

One embodiment of the present application includes a fuel nozzle assembly for an aircraft gas turbine engine, wherein the fuel nozzle assembly includes, among other things, two swirlers and a mounting device. The swirlers are attached to the fuel nozzle assembly and are used to impart a swirling motion to air as it flows through a combustor so as to improve combustion efficiency and reduce NOx emissions. The mounting device is useful for mounting the fuel nozzle to an interior mounting surface of a combustor casing so that the interface between the mounting device and mounting surface is pressure loaded.

One aspect of the present invention provides an apparatus comprising a fuel nozzle having a first end and a second end, the fuel nozzle including a mounting device disposed intermediate the first end and the second end, wherein the mounting device is configured to be coupled with a mounting surface located internal to a combustor casing of a gas turbine engine and a first swirler and a second swirler coupled to the fuel nozzle body.

One feature of the present application provides wherein the first swirler and second swirler are integrally formed in the fuel nozzle.

Another feature of the present application provides wherein the second swirler is releasably coupled to the fuel nozzle.

Yet another feature of the present application provides wherein the mounting device is a flange and wherein at least a portion of the fuel nozzle extends past the flange.

Still another feature of the present application provides wherein the mounting surface is a mount pad.

Another aspect of the present application provides an apparatus comprising a combustor casing having a mounting surface disposed internal to the combustor casing, a combustor liner disposed internal to the combustor casing and a fuel nozzle having a first swirler and a mounting device, wherein the mounting device is configured to be received by the mounting surface of the combustor casing, wherein the combustor liner is radially offset from the first swirler.

One feature of the present application provides a second swirler.

Another feature of the present application provides wherein the second swirler is releasably detachable from the fuel nozzle.

Still another feature of the present application provides wherein the combustor liner includes an inner liner and an outer liner.

Still a further feature of the present application provides a diffuser disposed upstream of the first swirler.

Yet a further feature of the present application provides wherein the mounting surface is a mount pad.

Yet another feature of the present application provides wherein the mounting device is a flange.

Still another feature of the present application provides a gas turbine engine that includes the combustor casing and fuel nozzle.

Yet another aspect of the present application provides a method comprising providing a fuel nozzle having a first and second swirler disposed in a first portion of the fuel nozzle and a mounting device disposed in a second portion of the fuel nozzle and joining the mounting device to a mounting surface formed on an internal surface of a combustor casing wherein the fuel nozzle is mounted to the combustor casing.

Still another aspect of the present application provides a method comprising providing a fuel nozzle having a first and second swirler disposed in a first portion of the fuel nozzle, and configuring the fuel nozzle with a mounting device disposed in a second portion of the fuel nozzle, wherein the mounting device is adapted to be received by an internal surface of a combustor casing.

One aspect of the present application provides an apparatus comprising a fuel nozzle assembly having a first swirler and a tip, and a second swirler included in the fuel nozzle assembly and having a second swirler exit, wherein the relative location of the second swirler exit and the fuel nozzle tip are structured to reduce NOX emissions.

One feature of the present application provides wherein the fuel nozzle assembly is configured to be internally received and mounted within a combustor casing.

Another feature of the present application provides wherein the second swirler is integrally formed with the fuel nozzle assembly.

Yet another feature of the present application provides a flange disposed on the fuel nozzle and configured to be received by a mounting surface of the combustor casing.

One aspect of the present application provides an apparatus comprising a gas turbine engine having a combustor for burning a fuel and air mixture, the gas turbine engine including a mounting portion for receiving a combustor component, a gas turbine engine fuel nozzle having a fuel injection portion for providing fuel to the combustor and a mounting member for being coupled to the gas turbine engine, the gas turbine engine fuel nozzle coupled with a swirler for swirling a working fluid upstream of a combustion process within the gas turbine engine, the gas turbine engine fuel nozzle and coupled swirler forming a nozzle assembly, and wherein the nozzle assembly has an uninstalled position and an installed position, the uninstalled position separate from the gas turbine engine, the installed position characterized by the mounting member being pressure loaded toward the mounting portion during operation of the gas turbine engine.

One aspect of the present application provides an apparatus comprising a gas turbine engine combustor operable to combust a mixture of fuel and air and having a mounting portion within the combustor, the mounting portion proximate an opening through which a fuel conduit can pass to an internal position of the combustor, a fuel nozzle disposed within and coupled to the gas turbine engine combustor, the fuel nozzle having a swirler, a first end operable to flow a combustible fluid, and a mounting device, and wherein the orientation of the mounting device relative to the mounting portion prevents the fuel nozzle from being urged through the opening during operation of the gas turbine engine.

Another aspect of the present application provides an apparatus comprising a gas turbine engine fuel injector having a swirler for swirling an airflow passing through a combustor of a gas turbine engine, a combustor within which the gas turbine engine fuel injector is mounted, and means for coupling the gas turbine engine fuel injector with the combustor.

Still another aspect of the present application provides an apparatus comprising forming a gas turbine engine fuel nozzle assembly having an air swirler device, positioning the gas turbine engine fuel nozzle assembly within a combustor portion of an at least partially constructed gas turbine engine, and engaging a mounting surface of the gas turbine engine fuel nozzle assembly with the combustor portion, the engaging including preventing the gas turbine engine fuel nozzle assembly from passing through an aperture in a combustor of the gas turbine engine that conveys fuel to the gas turbine engine fuel nozzle assembly.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. An apparatus comprising:
a gas turbine engine having a combustor for burning a fuel and air mixture, the gas turbine engine including a mounting portion for receiving a combustor component;
a gas turbine engine fuel nozzle having a fuel injection portion for providing fuel to the combustor and a mounting member for being coupled to the gas turbine engine, the gas turbine engine fuel nozzle coupled with a swirler for swirling a working fluid upstream of a combustion process within the gas turbine engine, the gas turbine engine fuel nozzle and coupled swirler forming a nozzle assembly; and
wherein the nozzle assembly has an uninstalled position and an installed position, the uninstalled position separate from the gas turbine engine, the installed position characterized by the mounting member being pressure loaded toward the mounting portion during operation of the gas turbine engine.

2. The apparatus of claim 1, wherein the swirler includes a first and second swirler.

3. The apparatus of claim 2, wherein the first and second swirler are separately coupled to the gas turbine engine fuel nozzle.

4. The apparatus of claim 1, wherein the combustor includes the mounting portion.

5. The apparatus of claim 1, wherein the mounting member is connected to the mounting portion.

6. The apparatus of claim 5, mounting member includes an extension from a portion of the fuel nozzle, the extension bearing against the mounting portion such that the extension is between the mounting portion and the fuel injection portion.

7. An apparatus comprising:
a gas turbine engine combustor operable to combust a mixture of fuel and air and having a mounting portion within the combustor, the mounting portion proximate an opening through which a fuel conduit can pass to an internal position of the combustor;
a fuel nozzle disposed within and coupled to the gas turbine engine combustor, the fuel nozzle having a swirler, a first end operable to flow a combustible fluid, and a mounting device; and
wherein the mounting device includes a protrusion larger than the opening such that during operation of the gas turbine engine the protrusion extends beyond the opening to prevent the fuel nozzle from being urged through the opening.

8. The apparatus of claim 7, wherein the when the mounting device is connected to the mounting portion.

9. The apparatus of claim 8, wherein opposing outer portions of the mounting device extends past outer portions of the opening.

10. The apparatus of claim 8, wherein the swirler is coupled with the fuel nozzle when the mounting device is separate from mounting portion.

11. The apparatus of claim 8, wherein the swirler includes a plurality of swirlers.

12. The apparatus of claim 11, wherein the plurality of swirlers are coupled with the fuel nozzle when the mounting device is separate from mounting portion.

13. The apparatus of claim 8, which further includes a gas turbine engine.

14. An apparatus comprising:
a gas turbine engine fuel injector having a swirler for swirling an airflow passing through a combustor of a gas turbine engine;
a combustor within which the gas turbine engine fuel injector is mounted; and
means for coupling the gas turbine engine fuel injector with the combustor.

15. The apparatus of claim 14, which further includes a gas turbine engine.

16. An apparatus comprising:
forming a gas turbine engine fuel nozzle assembly having an air swirler device;
positioning the gas turbine engine fuel nozzle assembly within a combustor portion of an at least partially constructed gas turbine engine; and
engaging a mounting surface of the gas turbine engine fuel nozzle assembly with the combustor portion, the engaging including preventing the gas turbine engine fuel nozzle assembly from passing through an aperture in a combustor of the gas turbine engine that conveys fuel to the gas turbine engine fuel nozzle assembly.

17. The method of claim 16, wherein the forming includes providing a first swirler and a second swirler to the gas turbine engine fuel nozzle.

18. The method of claim 17, wherein the fastening includes separately attaching the second swirler.

19. The method of claim 16, wherein the engaging includes orienting the mounting surface such that a pressure within the gas turbine engine during operation acts to load the mounting surface toward the combustor portion.

20. The method of claim 17, wherein the preventing includes abutting an outer portion of the mounting surface to the combustor portion.
